(19) United States
(12) Patent Application Publication
(10) Pub. No.: US 2022/0049957 A1
(43) Pub. Date: Feb. 17, 2022

(54) GYROSCOPE DEVICES WITH CONTROL ROTORS AND REACTION WHEELS

(71) Applicant: Hewlett-Packard Development Company, L.P., Spring, TX (US)

(72) Inventors: Jonathan Michael Anderson, Fort Collins, CO (US); Matthew Flach, Fort Collins, CO (US)

(73) Assignee: Hewlett-Packard Development Company, L.P., Spring, TX (US)

(21) Appl. No.: 17/415,793

(22) PCT Filed: Apr. 2, 2019
(86) PCT No.: PCT/US2019/025424

§ 371 Date: Jun. 18, 2021

(51) Int. Cl. G01C 19/30; H04N 13/332

(52) U.S. Cl. CPC G01C 19/30; H04N 13/332

(57) ABSTRACT

In an example, a gyroscope device may include a control rotor to spin about a central axis and a reaction wheel to spin about the central axis, independent of the control rotor. An example gyroscope device may also include an actuator to change the orientation of the control rotor.

### BACKGROUND

Electronic devices such as computing devices may provide an immersive audio-visual (AV) experience for a user. Such devices may include virtual-reality (VR) and augmented-reality (AR) computing devices or systems. Such devices may include a head-mounted display (HMD) which may provide a visual display of content for the user. Such HMD's may provide realistic and immersive visual data and/or content, which may encourage the user to feel like s/he is experiencing the visual scenario first-hand or in real life. Additionally, VR and/or AR systems may also provide audio signals and/or content to the user, from headphones or speakers, that is in-sync with the visual content and may also be directional in nature, thereby increasing the immersive experience for the user.

### BRIEF DESCRIPTION OF THE DRAWINGS

FIG. 1 is a side view of an example gyroscope device.

FIG. 2A is a side view of an example VR system having an example gyroscope device.

FIG. 2B is a side view of an example VR system having an example gyroscope device.

FIG. 2C are front and side views of an example gyroscope device.

FIG. 2D are top views of an example gyroscope device.

FIG. 3 is a perspective view of an example gyroscope device.

### DETAILED DESCRIPTION

Electronic devices such as VR and AR computing devices and systems may provide an immersive simulated audio-visual experience for a user, providing the user the sense that they are immersed within, and experiencing first-hand, the content of which they are seeing and hearing. In some situations, it may be desirable to enhance the immersive experience further by also providing an additional sensory input that corresponds or syncs with the audio-visual content. Such additional sensory input may provide a haptic feedback, for example, a vibration through the VR HMD, headphones or speakers, through hand-held controllers or handles, through haptic suits or vests worn on the user's chest or body, or through boots or other footwear. Sometimes a walking or movement pad or treadmill may even be employed to simulate to the user the ability to walk or move around in the virtual environment that they are experiencing. Such haptic feedback or felt force, however, is generally fleeting, temporary, mild, or in other ways less realistic than desirable.

In some situations, it may be desirable to employ a VR computing system or device that has the capability to provide sustained force or haptic feedback to the user to further simulate the virtual environment and make the experience more realistic, for example, when simulating gravitational forces (G forces). Additionally, in some situations, it may be further desirable to assist or resist the turning of the user's head, hand, or other body member in response to the audio-visual experience to either make the VR experience less taxing on the user's neck or other body member, more taxing on the user's arms or other body member, or to further enhance the realism of the experience, depending on the content being viewed.

Implementations of the present disclosure provide gyroscope devices that are able to impart a sustained torque and/or force on a user's body while the user is experiencing VR content, thus increasing the realism of the simulated environment.

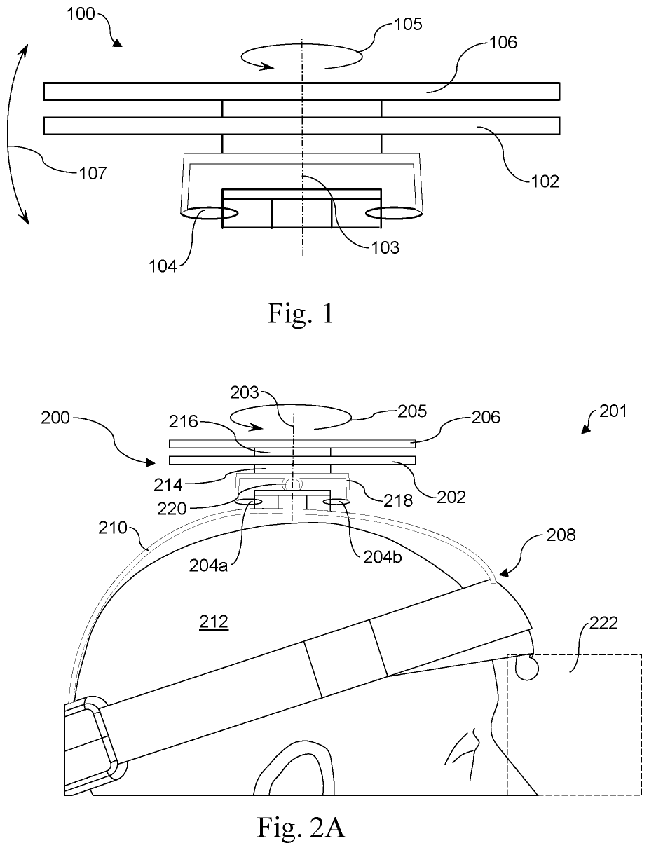

Referring now to FIG. 1, a side view of an example gyroscope device 100 is illustrated. Gyroscope device 100 may include a control rotor 102 to spin about a central axis 103, an actuator 104 to change the orientation of the control rotor 102, and a reaction wheel 106 to spin about the central axis 103, for example along direction 105, independent of the control rotor 102. It should be noted that, while FIG. 1 illustrates the control rotor 102 and the reaction wheel 106 as able to spin along direction 105 in a counter-clockwise manner, the control rotor 102 and the reaction wheel 106 may also or instead spin along a direction opposite to that of direction 105. In other words, the control rotor 102 and the reaction wheel 106 may be able to spin in either a clockwise or counter-clockwise manner.

The control rotor 102 may be a rigid or semi-rigid member capable of spinning about a central axis, which may be a longitudinal axis such as central axis 103. In some implementations, the control rotor 102 may spin at a constant angular speed, e.g., a constant number of radians or degrees per a unit of time. In other implementations, the control rotor 102 may accelerate or decelerate its angular speed, and in further implementations, the control rotor 102 may have a varying, undulating, reciprocating, or otherwise changing angular speed. In yet further implementations, the angular speed of the control rotor 102 may change in accordance with a pattern or predetermined manner.

The control rotor 102 may be a round or cylindrical disk, in some implementations. In further implementations, the control rotor 102 may be of an oblong, oval, rectangular, or another shape capable of generating angular momentum when spun. In some implementations, the control rotor 102 may have a uniform thickness, while in other implementations it may have a varying thickness. In yet further implementations, the control rotor 102 may have spokes, windows, apertures, or other support or weight-reduction features. In some implementations, the control rotor 102 may be a control-moment gyroscope (CMG).

The actuator 104 may be a motive element or may include a motive element capable of tilting, angling, or otherwise modifying the orientation of the control rotor 102 while it is spinning. The actuator 104 may be able to move or rotate the control rotor 102 about any axis of motion orthogonal to the central axis 103. For example, the actuator 104 may be able to tilt the control rotor 102 in a direction similar to that illustrated by example direction 107, parallel to the view plane of FIG. 1 and about an axis of rotation parallel to the view plane of FIG. 1. Additionally, for example, the actuator 104 may be able to move or tilt the control rotor 102 in a direction that is normal, orthogonal, or at an angle to the view plane of FIG. 1. In some implementations, the actuator 104 may include a motive element such as a servo motor and/or other features such as linkages, arms, supports, or other components to transfer the force or motion of the motive element to the control rotor 102 so as to change the orientation of the control rotor 102. In further implementations, the actuator 104 may be capable of moving the control rotor 102 in a dynamic fashion, i.e., constantly changing its orientation. The actuator 104 may further be able to hold the control rotor 102 in a desired orientation for extended periods of time while the control rotor 102 is spinning.

The reaction wheel 106 may also spin about the central axis 103, e.g., along direction 105. The reaction wheel 106, in some implementations, may be similar in structure to that of the control rotor 102. For example, the reaction wheel 106 may be a rigid or semi-rigid disk or wheel-shaped element. In some implementations, the reaction wheel 106 may be larger or smaller in diameter, and/or thicker or thinner in width than the control rotor 102. In further implementations, the reaction wheel 106 may remain angularly stationary about the central axis 103 while the control rotor 102 spins. In some implementations, the reaction wheel 106 may angularly accelerate or decelerate about the central axis 103 while the control rotor 102 spins at a constant or substantially constant angular speed. In this context, substantially constant angular speed may refer to a speed that is about constant but may include minor variations in speed due to environmental factors, motive element variations or tolerances, global movement of the gyroscope device 100 as a whole, or other considerations that may affect the angular speed of the control rotor 102 on a minor scale. The reaction wheel 106 may exert a reactionary torque about the central axis 103 against components connected to or supporting the reaction wheel 106, with such reactionary torque being opposite in direction and proportionate to the amount of angular acceleration of the reaction wheel 106. In further implementations, the reaction wheel 106 may tilt or change orientation with the control rotor 102, as caused or initiated by the actuator 104.

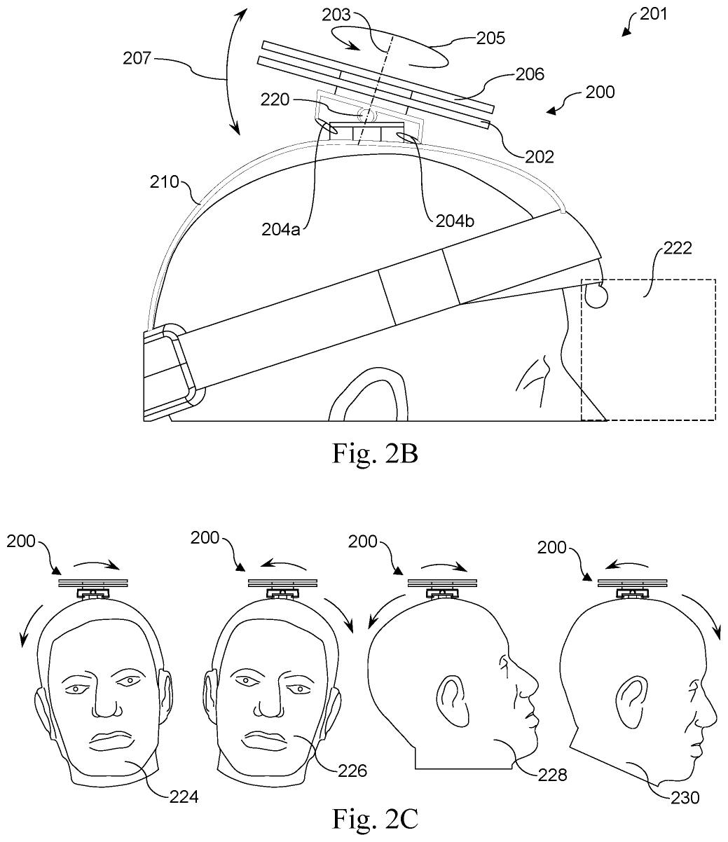

Referring now to FIG. 2A, a side view of an example virtual-reality (VR) system 201 having an example gyroscope device 200 is illustrated. Example gyroscope device 200 may be similar to example gyroscope device 100, described above. Further, the similarly-named elements of example gyroscope device 200 may be similar in function and/or structure to the respective elements of example gyroscope device 100, as they are described above. VR system 201 may include a chassis 208 to mount the VR system to a user. In some implementations, the chassis 208 may mount the VR system to a head 212 of the user, shown generically in FIG. 2A. The VR system 201 may also include a VR headset and/or head-mounted display (HMD) 222 attached to the chassis 208. The HMD may provide visual and/or audio content corresponding to a virtual or simulated environment to the user. HMD 222 is shown in phantom in FIG. 2A for simplicity and clarity and may have a size, structure, form factor, and/or location on the chassis 208 different than illustrated. In some implementations, the term head-mounted display (HMD) may refer to the audio-visual-providing component of the VR system together with the chassis. The chassis 208 may include a mounting band 210, in some implementations. Further, in some examples, the chassis 208 and/or mounting band 210 may be considered to be a part of the gyroscope device 200. The chassis 208 and/or mounting band 210 may be sufficiently rigid or stiff, and may be worn by a user in a sufficiently tight or snug fashion such that the VR system 201 is firmly and securely attached to the user. In further implementations, the chassis 208 may extend around the circumference of a user's head, and the mounting band 210 may extend up and over the top of the user's head. In such an example, the gyroscope device 200 may be attached to the mounting band 210 such that it is substantially disposed on top of the head of the user. It should be noted that other configurations are contemplated and considered to be within the scope of this disclosure. For example, in some implementations, the gyroscope device 200 may be mounted closer to or on the HMD 222. In other examples, the gyroscope device 200 may be a peripheral device that is physically separate from the HMD 222 and/or the chassis 208, such as a glove or integrated into a VR hand-held controller or handle. It should also be noted that the gyroscope device 200 may have a differing size and/or form factor than is illustrated in the figures. In yet further implementations, the VR system 201 may include additional gyroscope devices (not shown). For example, some VR systems contemplated by the present disclosure may include a gyroscope device disposed on top of the user's head, as well as any number of additional gyroscope devices disposed on the HMD, the chassis 208, and/or on peripheral devices such as hand-held controllers or body suits or vests. Such a plurality of gyroscope devices may be controlled in concert by the VR system such that they operate in a cooperative manner with one another.

The gyroscope device 200 may include a control rotor 202 and a reaction wheel 206 disposed adjacent and coaxially to the control rotor, the control rotor 202 and the reaction wheel 206 to spin about a central axis 203, relative to the chassis 208 and/or mounting band 210, for example, along direction 205. As noted above, in other examples, the control rotor 202 and the reaction wheel 206 may also be capable of spinning in an opposite direction to 205, and, in some implementations, opposite in direction to one another. Stated differently, the control rotor 202 may spin along direction 205, while the reaction wheel 206 may accelerate and/or decelerate along direction 205, or along a direction opposite to 205, depending on the visual and/or audio content the user is experiencing through the VR system. The gyroscope device 200 may include a first motive element 214 engaged with the control rotor 202 and a second motive element 216 engaged with the reaction wheel 206. Each motive element may be capable of spinning the respective control rotor 202 or reaction wheel 206 about central axis 203, independent of each other. Thus, the control rotor 202 may be able to spin at a substantially constant angular speed, while the reaction wheel 206 is either not spinning, or accelerating or decelerating at a predetermined or selective amount. Stated differently, the reaction wheel 206 may selectively angularly accelerate and/or decelerate relative to the angular speed of the control rotor 202. In some implementations, the first and second motive elements 214 and 216 may include electric motors, gears, transmissions, clutches, or other components to enable the independent operation of the control rotor 202 and the reaction wheel 206 from one another. In further implementations, each of the control rotor 202 and the reaction wheel 206 may be driven by a single motive element, and may each have separate gearing, clutches, transmissions, etc. to provide the independent operation of each from one another.

The control rotor 202, reaction wheel 206, and/or the gyroscope device 200 as a whole may be mounted on or attached to the chassis 208 and/or mounting band 210 by a multi-directional mount 220, which may enable the gyroscope device 200 to tilt relative to the chassis 208 and/or mounting band 210 in a variety of directions, and about multiple different axes. In some implementations, the multi-directional mount 220 may include a ball and socket joint and may enable the control rotor 202 and the reaction wheel 206 to pivot about multiple axes extending through the ball of the ball and socket joint.

The gyroscope device 200 may further include a first actuator 204a and a second actuator 204b to alter the orientation of the control rotor 202 and the reaction wheel 206 relative to the chassis 208 and/or mounting band 210. In some implementations, the gyroscope device 200 may include a single actuator, and in other implementations, may include multiple actuators working together in a complementary fashion so as to selectively alter the orientation of the gyroscope device 200. The control rotor 202 may spin at a substantially constant angular speed so as to apply a force on the chassis 208 through its gyroscopic effect. Further, the actuator or actuators may alter the orientation of the control rotor 202 and the reaction wheel 206 relative to the chassis 208, and thus, the user, so as to alter the force exerted on the chassis 208, and thus, the user or a user's head, by a gyroscopic effect of the control rotor 202 resulting from the angular momentum of the control rotor 202 when it is spinning.

In some implementations, the control rotor 202 and the reaction wheel 206 may be attached to the multi-directional mount 220, and thus the chassis 208 and/or mounting band 210, by a frame 218. The frame 218 may have a variety of structures and/or appearances, but may serve as a component or components to mount the control rotor 202 and the reaction wheel 206 to the chassis 208 and/or mounting band 210 by way of the multi-directional mount 220. In some implementations, the frame 218 may include supporting structures such as spindles, axles, bearings, motor mounts and/or other components to establish the mount and support for the control rotor 202 and the reaction wheel 206. The frame 218 may also provide supporting structures, drive trains, clutches, gears, etc. for the first and second motive elements 214 and 216.

Referring now to FIG. 2B, a side view of the example VR system 201 is illustrated wherein the actuator or actuators has altered the orientation of the control rotor 202 and the reaction wheel 206, relative to the chassis 208, and thus the user. For example, the first actuator 204a and the second actuator 204b have each operated in conjunction with one another so as to tilt the control rotor 202 and the reaction wheel 206 along direction 207, relative to the user. Similarly, the actuator or actuators may operate to tilt the control rotor 202 and the reaction wheel 206 in other directions, about axes that extend orthogonally to the central axis 203, through the multi-directional mount 220.

Referring additionally to FIG. 2C, front and side views of the gyroscope device 200 are illustrated as to how it could affect a user utilizing the VR system 201. In state 224, the actuators have tilted the gyroscope device 200 to the right in the plane of view. Such an alteration of the orientation of the control rotor 202, while it is spinning, may exert an opposite and proportional reactionary force on to the user due to the angular momentum and gyroscopic effect of the spinning control rotor. Thus, the user may experience a force pushing on them towards the left. It should be noted that in these examples, the user is illustrated as physically moving or tilting in a certain direction in order to illustrate the direction of force applied to the user by the gyroscope device 200, when in some implementations, the user may actually remain stationary while experiencing this force. In state 226, the gyroscope device 200 is tilted to the left in the plane of view, thereby exerting a reactionary force on the user to the right. In state 228, the gyroscope device 200 is tilted forward relative to the user, thereby exerting a reactionary force on the user to the back. Finally, in state 230, the gyroscope device 200 is tilted backward relative to the user, thereby exerting a reactionary force on the user to the front.

While FIG. 2C illustrates the gyroscope device 200 pitching and rolling the user's head by tilting in four directions about axes extending orthogonally to the central axis, it should be noted that any combination of these tilting directions is contemplated. Thus, the actuators may tilt the gyroscope device 200 partially in one direction and partially in another at the same time, thereby resulting in a diagonal reactionary force being exerted on the user. Therefore, the gyroscope device 200 may be able to provide a reactionary force on the user in any direction about an axis orthogonal to the central axis.

Referring now to FIG. 2D, top views of the gyroscope device 200 are illustrated as to how it could affect a user utilizing the VR system 201. Examples of reaction wheel 206 are illustrated, while the rest of the elements of the example gyroscope device 200 have been omitted for clarity. In some implementations, the reaction wheel 206 may spin, for example by way of second motive element 216 of FIG. 2A, about the central axis. Further, the reaction wheel 206 may angularly accelerate about the central axis. In state 232, the reaction wheel 206 may be angularly accelerated in a counter-clockwise manner, and thus may exert a reactionary torque in the opposite, clockwise direction about the central axis on the user or the user's head. Such reactionary torque may be exerted on the user in the manner indicated in FIG. 2D. Thus, if it is beneficial or more immersive for the user to experience a twisting or turning force due to the virtual environment that the user is experiencing, then the gyroscope device 200 may be employed to simulate such a force. Similarly, in state 234, the reaction wheel 206 may be accelerated in a clockwise manner, thereby exerting a reactionary torque in the opposite, counter-clockwise direction against the user, as indicated in FIG. 2D. It should be noted that the reaction wheel 206 may spin, accelerate, or decelerate independently from the control rotor. Thus, the control rotor may be spinning at a constant rate, and the reaction wheel 206 may be stationary by default. Then, when it is beneficial for the user to experience a twisting or turning force, the reaction wheel 206 may be activated and accelerate to the desired amount and in the desired direction to achieve the desired effect.

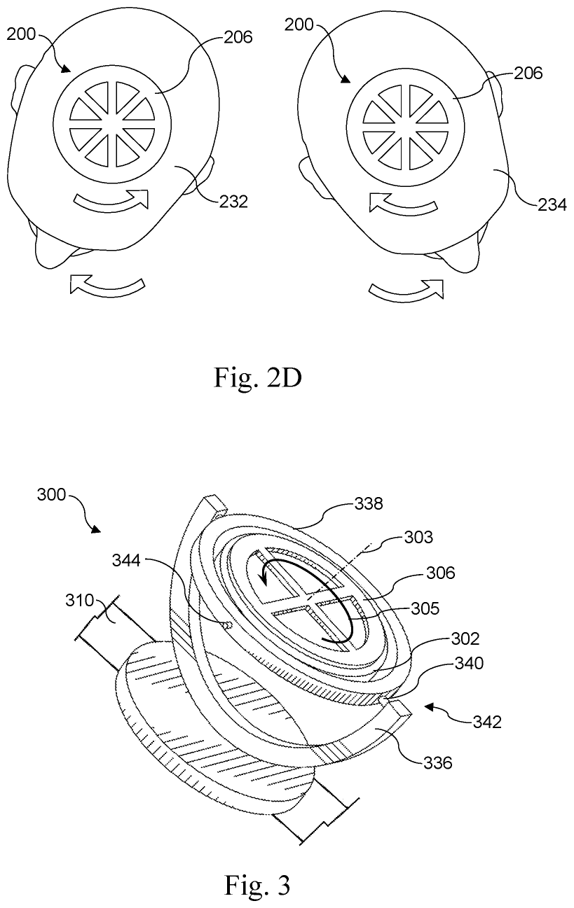

Referring now to FIG. 3, a perspective view of an example gyroscope device 300 is illustrated. Example gyroscope device 300 may be similar to other example gyroscope devices, described above. Further, the similarly-named elements of example gyroscope device 300 may be similar in function and/or structure to the respective elements of other example gyroscope devices, as they are described above. In some implementations, the gyroscope device 300 may be mounted on a gimbal 342. The gimbal 342 may be able to selectively lock and unlock the movement of the gyroscope device 300 relative to a mounting band 310 or chassis on which the gyroscope device 300 is mounted. For example, the gimbal 342 may include a roll axis gimbal 336 and a pitch axis gimbal 338. The roll axis gimbal 336 may be fixedly attached to the mounting band 310 either directly or indirectly through intermediary components, and may also be pivotably attached to the pitch axis gimbal 338 through a roll pivot 340. Further, the pitch axis gimbal 338 may be attached to a control rotor 302 and a reaction wheel 306 of the gyroscope device 300 through a pitch pivot 344.

The roll pivot 340 may provide a pivot point for the pitch axis gimbal 338 to rotate relative to the roll axis gimbal 336. The roll pivot 340 may also be able to selectively lock the pitch axis gimbal 338 relative to the roll axis gimbal 336 such that the pitch axis gimbal 338 cannot pivot or rotate about the roll pivot 340. Similarly, the pitch pivot 344 may provide a pivot point for the control rotor 302 and the reaction wheel 306 to pivot or rotate relative to the pitch axis gimbal 338, and the pitch pivot 344 may also be able to selectively lock the control rotor 302 and the reaction wheel 306 relative to the pitch axis gimbal 338 such that they cannot pivot or rotate about the pitch pivot 344. Thus, the gimbal 342 provides an ability to isolate forces generated by the control rotor 302 while it is spinning about the central axis 303, e.g., along direction 305, and prevent those forces from being transmitted to the mounting band 310 and/or chassis to which the gyroscope device 300 is attached. In other words, if the control rotor 302 is spinning and thus generating a reactionary force due to angular momentum and its gyroscopic effect, one or both of the roll pivot 340 and the pitch pivot 344 can be unlocked such that the control rotor 302 is free to move relative to the mounting band 310, and thus is isolated and not transferring reactionary forces to the user. This may increase the comfort level of a user. If it is desirable to then transmit a reactionary force to the user, as described above, one or both of the roll pivot 340 and the pitch pivot 344 may lock, preventing independent movement of the control rotor 302 and transferring such reactionary forces to the user as desired. Stated yet differently, the gimbal 342 may selectively isolate a force generated by the control rotor 302 from the mounting band 310, and thus the user.

The ability to exert a force on the user may give to example gyroscope devices disclosed herein the ability to further simulate the experience that is being visually and auditorily presented to the user by the VR system. For example, if the user is experiencing a roller coaster or spaceship simulation with the VR system, an example gyroscope device may be employed to help simulate gravitational forces (G forces) or thrust forces on the user. Additionally, acceleration of the reaction wheel may provide twisting and turning sensations to the user. An example gyroscope device may also be employed to assist the user in enjoying the VR experience and/or help support movement of the user's head to help reduce strain induced by the weight of the VR system. For example, an example gyroscope device could be tilted forward to employ the rearward reactionary force to help offset the forward-pulling weight of the HMD, or the reactionary torque from the reaction wheel could be used to assist the user in turning their head. Thus, example gyroscope devices are able to enhance the realism of the virtual environment and also make the VR system more comfortable to use by providing sustained haptic feedback to the user, thereby improving the user's experience.

What is claimed is:

1. A gyroscope device, comprising:
a control rotor to spin about a central axis;
an actuator to change the orientation of the control rotor; and
a reaction wheel to spin about the central axis independent of the control rotor.

2. The gyroscope device of claim 1, further comprising a multi-directional mount to mount the gyroscope device to a head of a user.

3. The gyroscope device of claim 2, wherein the control rotor is to spin at a substantially constant angular speed, and the actuator is to change the orientation of the control rotor relative to the head of the user so as to alter a force exerted on the head of the user by a gyroscopic effect of the control rotor.

4. The gyroscope device of claim 3, wherein the reaction wheel is to selectively angularly accelerate and decelerate, relative to the angular speed of the control wheel, such that the reaction wheel applies a torque to the head of the user about the central axis.

5. The gyroscope device of claim 1, wherein the control rotor and reaction wheel are attached to the multi-directional mount by a frame.

6. The gyroscope device of claim 1, wherein the reaction wheel is disposed adjacent and coaxial to the control rotor.

7. The gyroscope device of claim 1, wherein the control rotor is a control-moment-gyroscope (CMG).

8. A gyroscope device, comprising:
a chassis to mount the gyroscope device to a body member of a user, comprising a mounting band;
a control rotor attached to the mounting band by a multi-directional mount, the control rotor to spin relative to the chassis about a central axis;
a reaction wheel attached to the mounting band and disposed adjacent and coaxially to the control rotor; and
an actuator to alter the orientation of the control rotor and the reaction wheel relative to the chassis so as to alter a force exerted on the chassis by a gyroscopic effect of the control rotor.

9. The gyroscope device of claim 8, wherein reaction wheel is to selectively angularly accelerate and decelerate, relative to an angular speed of the control wheel, such that the reaction wheel applies a torque to the body member of the user about the central axis.

10. The gyroscope device of claim 8, wherein the actuator includes a servo motor.

11. The gyroscope device of claim 8, wherein the multi-directional mount includes a ball and socket joint.

12. The gyroscope device of claim 8, wherein the control rotor is attached to the mounting band by a gimbal, the gimbal to selectively isolate a force generated by the control rotor from the mounting band.

13. A virtual-reality (VR) system, comprising:
a chassis to mount the VR system to a head of a user;
a VR head-mounted display (HMD) attached to the chassis; and
a gyroscope device mounted on the chassis by a multi-directional mount, the gyroscope device comprising:
a control rotor to spin about a central axis;
a reaction wheel disposed adjacent and coaxially to the control rotor; and
an actuator to alter the orientation of the control rotor and the reaction wheel relative to the chassis so as to alter a force exerted on the chassis by a gyroscopic effect of the control rotor.

14. The VR system of claim 13, wherein the control rotor is to spin at a substantially constant angular speed so as to apply a force on the chassis through the gyroscopic effect.

15. The VR system of claim 14, wherein the reaction wheel is to selectively angularly accelerate and decelerate, relative to the angular speed of the control wheel, such that the reaction wheel applies a torque to the head of the user about the central axis.
